(19) United States
(12) Patent Application Publication
(10) Pub. No.: US 2008/0107834 A1
(43) Pub. Date: May 8, 2008

(54) COLOR FILTER SUBSTRATE AND METHOD FOR MANUFACTURING THE SAME

(75) Inventors: Hui-Fen Lin, Hsinchu (TW); Shu-Chin Lee, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/741,893

(22) Filed: Apr. 30, 2007

(30) Foreign Application Priority Data
Nov. 3, 2006 (TW) 95140706

(51) Int. Cl. C23F 1/04; C09K 19/52

(52) U.S. Cl. 428/1.51; 216/39; 428/1.53

(57) ABSTRACT

The invention provides a color filter substrate and a method for manufacturing the same, including a substrate, a plurality of color filters, and a plurality of banks. The banks separate the color filters, and the angle between the sidewall and the substrate is about 60° to 90°. The banks of the invention efficiently prevent cross-contamination of color materials, thereby improving the resolution of an LCD panel.

### BACKGROUND OF THE INVENTION

1. Field of the Invention

The invention relates to a color filter substrate, and in particular to banks thereon preventing cross-contamination of color materials.

2. Description of the Related Art

In general, an LCD comprises a liquid crystal layer disposed between a TFT array substrate and a color filter substrate. Manufacture of the color filter substrate comprises forming R, G, B organic materials in each pixel of the substrate, respectively. The color filter substrate is highest cost of the critical components of the LCD. In a 14.1-inch panel, the color filter substrate occupies 28% of total material cost, with backlight module and driving integrated circuits (IC) occupying 18% and 17%, respectively.

Coloration of the color filter substrate can utilize dye, pigment dispersal, printing, electro-deposition, or inkjet printing methods, with pigment dispersal the most popular. First, fine particles of dyes (R, G, B) are averagely dispersed in a transparent photosensitive resin. The color resins are spun, exposed, and developed to form R, G, B patterns. Typically, black matrix (BM) is formed between the R, G, B patterns to prevent light leakage. Black matrix is conventionally formed by sputtering single layer chromium film. Composite film of chromium and chromium oxide, or carbon mixed resin can be selected as a black matrix. In addition, a passivation film and ITO electrode layer are formed on the black matrix. Because the liquid crystal box comprises the color filter substrate and the TFT array substrate, pixels of these substrates are aligned with each other, a procedure requiring expensive color photoresist, with corresponding lithography consuming considerable time and labor. Accordingly, the pigment dispersal method increases costs.

U.S. Pat. No. 5,340,619 discloses a method of manufacturing a color filter substrate. First, a black matrix is formed on a substrate, and part of the black matrix is ablated by laser. The ablation regions are filled with color material by spin coating. After curing, only desired color material (such as R region) remains, and the color material in other ablation regions (such as G or B region) is removed by plasma or laser. Repeated laser ablation, spin coating, curing, and removing redundant material results in the completed color filter substrate. The process consumes considerable color material. Moreover, spin coating requires subsequent additional polishing to avoid cross-contamination of color materials.

FIGS. 1A-1F show an inkjet method reducing high cost of the pigment dispersal method. As shown in FIG. 1A, a photosensitive bank layer 12 serving as a black matrix layer is formed on a substrate 10. FIGS. 1B-1C show sequential steps in which the bank layer 12 is exposed by photomask 11 and developed to define a plurality of banks 14. Angle θ between the banks 14 sidewalls and the substrate 10 is less than 60°. FIG. 1D shows a surface treatment resulting in banks 14 having a color material-phobic top surface and color material-philic sidewalls. As shown in FIGS. 1E-1F, ablation regions are filled by ink 16 by color material nozzle 17. After hard baking, the color filters 19 are formed, thereby completing a color filter substrate 18. As shown in FIG. 1G, mixed color materials 16 degrade quality of the color filter substrate 18.

### BRIEF SUMMARY OF THE INVENTION

The invention provides a method for manufacturing a color filter substrate, comprising providing a substrate, forming a bank layer on the substrate, ablating part of the bank layer to define a plurality of ablation regions and a plurality of banks, wherein the ablation regions are separated by the banks, processing a surface treatment, such that the banks have color material-phobic top surface, filling at least one color material into the ablation regions, respectively; and hard baking the color material.

The invention further provides a color filter substrate, comprising a substrate, a plurality of color filters, and a plurality of banks, wherein the color filters are separated by the banks, and the sidewalls of the banks and the substrate form an angle of about 60′ to about 90°.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A-1G are serial cross sections of a conventional process for color filter substrate; and

FIGS. 2A-2E are serial cross sections of process in an embodiment of the invention for color filter substrate.

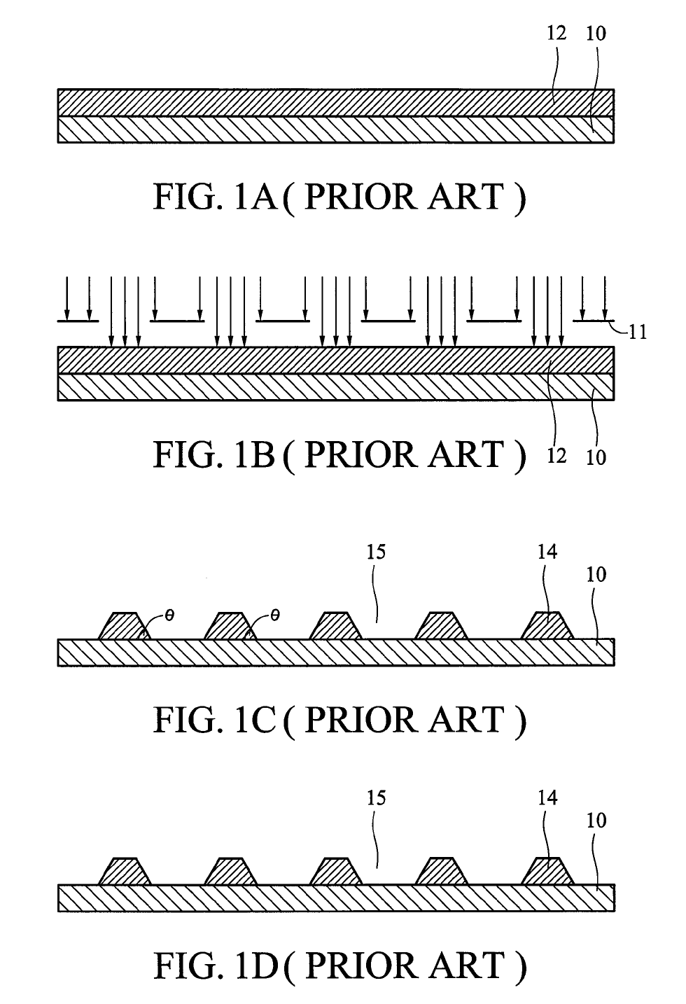

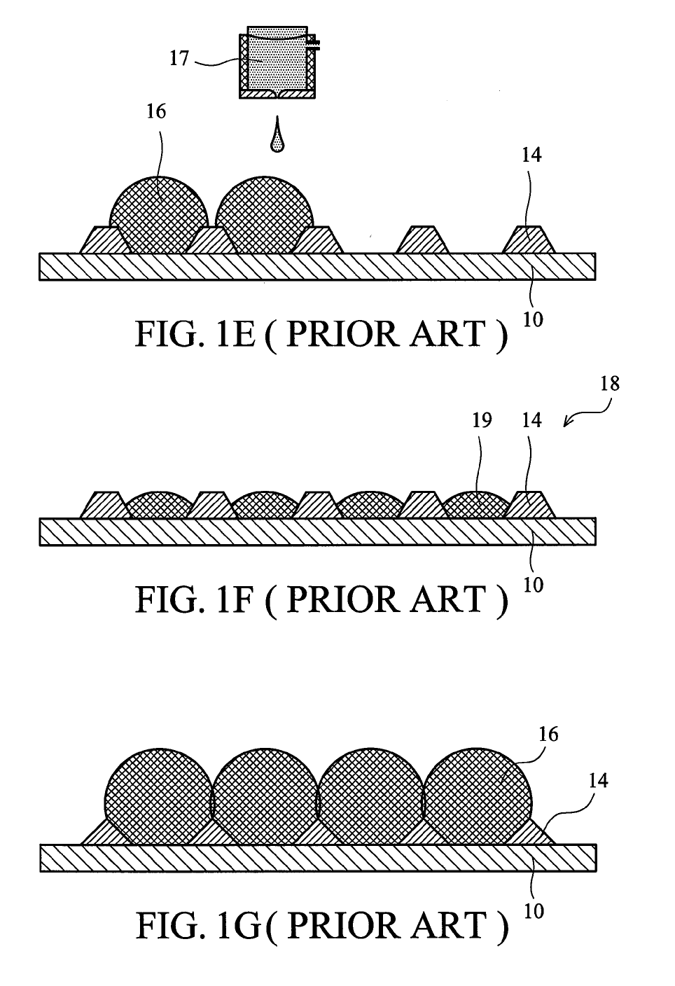

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

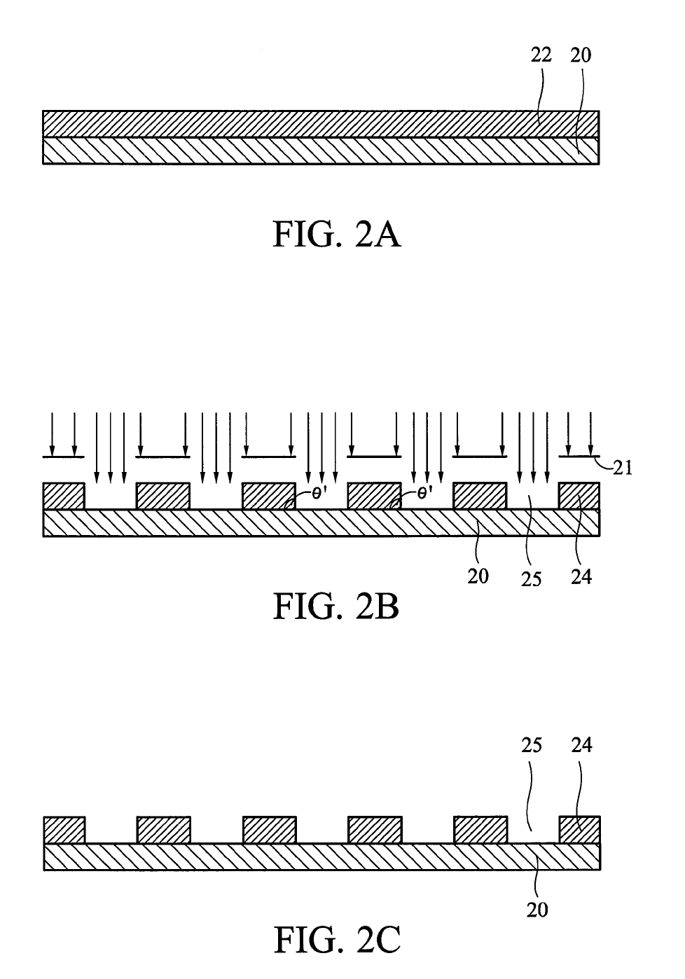

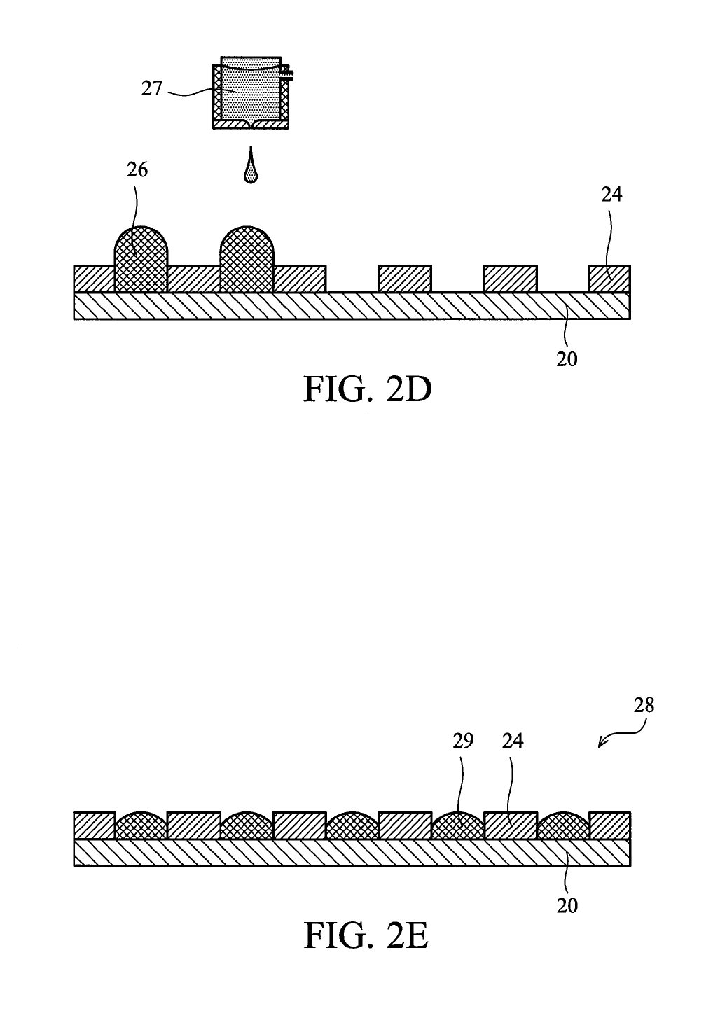

As shown in FIG. 2A, the invention provides a bank layer 22 on a substrate 20. The substrate 20 includes flexible transparent material (such as plastic) or inflexible transparent material (such as glass or quartz). The bank layer 22 may serve as a black matrix layer. Because the bank layer 22 is ablated, it can be photosensitive or photo-insensitive. Photosensitive material includes a liquid photoresist dissolved in solvent, a liquid resin, a dry film photoresist, or transfer film photoresist. For example, the photosensitive material can be acrylic resin, epoxy resin, or polyimide resin, wherein the resins have photosensitive functional groups. The photosensitive material may be mixed with dye, pigment, or carbon black to reduce transparency of the photosensitive material. The photo-insensitive material may be acrylic resin, epoxy resin, or polyimide resin. Similar to the photosensitive material, the photo-insensitive material may be mixed with dye, pigment, or carbon black. Photo-insensitive material does not need functional groups, thereby reducing the material cost. Alternatively, photo-insensitive material can be metal material such as chromium or chromium oxide. If wet photosensitive material is adopted as bank layer 22, it is preferable to process a pre-hard baking to remove solvent from photosensitive material before ablation. In an embodiment, the pre hard baking is preferably at about 150° C. to 250° C., and more preferably at about 220° C.

As shown in FIG. 2B, a photo mask 21 is used to apply a removing process, part of the bank layer 22 is defined to banks 24 and recesses (for example, ablation regions 25) separated by the banks 24. If lithography serves as removing process, the previously formed bank layer 22 is photosensitive material. If laser process such as solid state laser or eximer laser serves as removing process, the bank layer 22 can be inexpensive photo-insensitive material. Optionally, the laser process can directly write or combine a photo mask to define the banks 24. The banks 24 defined by the removing process have sidewalls, which and substrate 20 form an angle θ′ of about 60° to 90°. Because of diffraction, exposure value of the top surface exceeds bottom of conventional banks, such that banks formed by conventional lithography have sidewalls contacting substrate at less than 60°. The banks 24 of the present embodiment have a thickness of about 0.5 μm to about 5.0 μm.

As shown in FIG. 2C, a surface treatment such as plasma treatment is then processed, providing banks 24 with color material-phobic top surface and color material-philic sidewalls. If the color material is hydrophilic, a suitable surface treatment is adopted to provide banks 24 with hydrophilic sidewalls and hydrophobic top surface. If color material is hydrophobic, another type of surface treatment is adopted to make banks having hydrophobic sidewalls and hydrophilic top surface.

As shown in FIG. 2D, color materials 26 are then filled into ablation regions 25 in turns. Apply a filling process to fill at least one color material into the ablation regions 25, respectively. Note that although only one color material nozzle 27 is shown in FIG. 2D, it is possible to utilize a plurality of color material nozzles (not shown) to fill different color materials 26 into different ablation regions 25 simultaneously or non-simultaneously. The color material 26 can be red ink, blue ink, green ink, or cyan ink. Color material 26 is optionally hydrophilic or hydrophobic, corresponding to the properties of the bank sidewalls. Because angle θ′ between the banks 24 sidewalls and the substrate 20 is about 60° to about 90°, the top surface width of the banks 24 will not reduce or disappear even with reduced critical dimension, thereby preventing cross-contamination of color materials.

Finally, as shown in FIG. 2E, the color material 26 is hard baked to form color filters 29 and further complete color filter substrate 28. The preferable temperature, which baking process provides, of the hard bake process is about 150° C. to about 250° C., and more preferably 220° C. The color of color filters 29 is determined by previously filled color material 26, such as red, green, blue, white, or cyan.

The banks 24 of the invention have a wider top surface in smaller size, thereby avoiding color mixing. Accordingly, the color filter substrate of the invention is suitable for use in high-resolution LCD panels.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for manufacturing a color filter substrate, comprising:
providing a substrate;
forming a bank layer on the substrate;
applying a removing process to remove part of the bank layer to form a plurality of recesses and a plurality of banks, wherein the recesses are separated by the banks and wherein the substrate and a sidewall of at least one of the plurality of banks form an angle of about 60° to about 90°;
applying a surface treatment to the banks such that the banks have color material-phobic top surface;
applying a filling process to fill at least one color material into the recesses, respectively; and
applying a hardening process to harden the color material.

2. The method as claimed in claim 1, wherein the removing process comprises providing an eximer laser or a solid-state laser.

3. The method as claimed in claim 1, wherein the removing process comprises utilizing a photo mask.

4. The method as claimed in claim 1, wherein the surface treatment comprises a plasma surface treatment.

5. The method as claimed in claim 1, wherein the filling process comprises an inkjet filling process.

6. The method as claimed in claim 1, wherein the color material is hydrophilic.

7. The method as claimed in claim 1, wherein the color material is hydrophobic.

8. The method as claimed in claim 1, further comprising applying a baking process to harden the bank layer between forming the bank layer on the substrate and applying the removing process to remove part of the bank layer.

9. The method as claimed in claim 8, wherein baking process is performed to provide a temperature of about 150° C. to about 250° C.

10. The method as claimed in claim 1, wherein the banks have color material-philic sidewalls.

11. The method as claimed in claim 1, wherein the hardening process is performed to provide a temperature of about 150° C. to about 250° C.

12. A color filter substrate, comprising:
a substrate;
a plurality of color filters; and
a plurality of banks;
wherein the color filters is separated by the banks, and a sidewall of at least one of the banks and the substrate form an angle of about 60° to about 90°.

13. The color filter substrate as claimed in claim 12, wherein the banks comprise photosensitive material.

14. The color filter substrate as claimed in claim 13, wherein the photosensitive material comprises acrylic resin, epoxy resin, polyimide resin, or combinations thereof.

15. The color filter substrate as claimed in claim 14, wherein the photosensitive material further comprises dye, pigment, carbon black, or combinations thereof.

16. The color filter substrate as claimed in claim 12, wherein the banks comprise photo-insensitive material.

17. The color filter substrate as claimed in claim 16, wherein the photo-insensitive material comprises resin or metal.

18. The color filter substrate as claimed in claim 12, wherein the banks have a thickness of about 0.5 μm to about 5.0 μm.

19. The color filter substrate as claimed in claim 12, wherein the banks have hydrophilic sidewalls and hydrophobic top surface.

20. The color filter substrate as claimed in claim 12, wherein the banks have hydrophobic sidewalls and hydrophilic top surface.
